(19) United States
(12) Patent Application Publication
(10) Pub. No.: US 2025/0211065 A1
(43) Pub. Date: Jun. 26, 2025

(54) Drive unit

(71) Applicant: ECO Garage Doors Pty Ltd, Dandenong South (AU)

(72) Inventor: Toan Dang, Kew (AU)

(21) Appl. No.: 18/987,545

(22) Filed: Dec. 19, 2024

(30) Foreign Application Priority Data
Dec. 22, 2023 (AU) 2023904213

(51) Int. Cl. H02K 11/00; E05F 15/665; F16H 57/02; F16H 57/025; F21S 4/20; F21Y 115/10; H02K 5/04; H02K 11/30

(52) U.S. Cl. CPC H02K 11/0094; E05F 15/665; F16H 57/025; H02K 5/04; H02K 11/30; E05Y 2201/10; E05Y 2400/612; E05Y 2400/85; E05Y 2600/61; E05Y 2600/626; F16H 2057/02034; F16H 2057/02082; F21S 4/20; F21Y 2115/10

(57) ABSTRACT

A drive unit for driving a panel-lift door. The drive unit includes a motor unit (that lifts the door), and a housing (including a movable portion) carrying one or more key components. The housing is reconfigurable in situ from an operative configuration (in which the movable portion is in an operative position and the housing shields, the motor unit and the one or more key components carried by the movable portion, from the view of an operator) and a service configuration in which the movable portion is in a service position and the motor unit and/or a key component is removable.

### CROSS-REFERENCE TO RELATED APPLICATIONS

This application claims priority to and the benefit of Australian Patent Application No. 2023904213, filed Dec. 22, 2023, the content of which is incorporated herein by reference in its entirety.

### FIELD OF THE INVENTION

The invention relates to a drive unit for a panel-lift door.

### BACKGROUND TO THE INVENTION

A typical panel-lift door comprises a stack of long rectangular panels. Each panel runs across the doorway and is hingedly connected to its vertical neighbour(s). A drive unit is mounted above head height at a distance inboard of the door commensurate with the height of the door. The drive unit has an upwardly projecting output shaft carrying a sprocket on which a drive chain or timing belt is mounted. The other end of the drive train is looped about an idler sprocket proximal the door. The top door panel is drawn inwardly by one run of the chain to open the door.

Many drive units incorporate a lighting arrangement that turn on for a period of time when the door is opened to illuminate the way for the operator as they make their way from their vehicle and out of the garage.

Drive units sometimes fail and otherwise need servicing from time to time.

Whilst existing drive units are widely accepted and have changed little in decades, the present inventor has recognised that existing drive units are bulky, ugly, cast shadows and are expensive to service. The present invention aims to provide improvements in and for panel-lift doors or at least to provide a useful alternative for those concerned with panel-lift doors.

It is not admitted that any of the information in this patent specification is common general knowledge, or that the person skilled in the art could be reasonably expected to ascertain or understand it, regard it as relevant or combine it in any way before the priority date.

### SUMMARY

One aspect of the invention provides a drive unit for driving a panel-lift door;

wherein the drive unit is mountable above an eyeline of an operator having a view;

the drive unit comprises
a motor unit that lifts the door;
a housing comprising a movable portion that moves from an operative position to a service position; and
one or more key components carried by the movable portion;

each of the one or more key components carried by the movable portion is one of a battery;
a motor controller that controls the motor unit;
a transformer that transforms mains supply to power the motor unit;
an electronic user-interface that defines, or sits behind, a user contactable portion to interface with a user; and
a lighting unit; and
an arrangement of light sources;

the housing is reconfigurable in situ from
an operative configuration in which the movable portion is in the operative position and the housing shields, the motor unit and the one or more key components carried by the movable portion, from the view of the operator; and
a service configuration in which the movable portion is in the service position and at least one of
   a) the motor unit and
   b) at least one of the one or more key components carried by the movable portion
is removable.

The movable portion may define a floor of the housing. Optionally the movable portion carries the battery. The movable portion may carry the motor controller. Preferably the service configuration is a configuration in which the motor unit is removable.

Preferably the drive unit comprises the transformer.

The drive unit preferably comprises one or more threaded fasteners by which the motor unit is mounted. Most preferably, the one or more threaded fasteners each has a head accessible from below by which the threaded fastener is removable to remove the motor unit from the drive unit in situ.

Another aspect of the invention provides a drive unit for driving a panel-lift door;

wherein the drive unit is mountable above an eyeline of an operator;

the drive unit comprises
a motor unit that lifts the door; and
a housing;

the housing comprises a movable portion that moves from an operative position to a service position;

the housing is reconfigurable in situ from
an operative configuration in which the movable portion is in the operative position and the housing shields the motor unit from the view of the operator; and
a service configuration in which the movable portion is in the service position and the motor unit is removable;

the drive unit comprises one or more threaded fasteners by which the motor unit is mounted;

wherein the one or more threaded fasteners each has a head accessible from below by which the fastener is removable to remove the motor unit from the drive unit in situ.

Preferably the motor unit comprises

a bracket through which the one or more threaded fasteners upwardly pass;

a gear box housing comprising bores; and

further threaded fasteners passing downwardly through the bracket and engaging the bores to fasten the gear box housing to the bracket.

Optionally the movable portion turns from transverse-to-upright in the operative position to upright in the service position. The movable portion may be hinged to turn from the operative position to the service position.

Preferably the drive unit comprises a fixed portion;

wherein the movable portion is hinged, to turn from the operative position to the service position, by a concealed hinge mechanism comprising an intermediate member connected to pivot relative to the each of the fixed portion and the movable portion about respective mutually parallel pivot axes.

Another aspect of the invention provides a drive unit for driving a panel-lift door;

wherein the drive unit is mountable above an eyeline of an operator;

the drive unit comprises
a motor unit that lifts the door; and
a housing;

the housing comprises a movable portion that moves from an operative position to a service position;

the housing is reconfigurable from
an operative configuration in which the movable portion is in the operative position and the housing shields the motor unit from the view of the operator; and
a service configuration in which the movable portion is in the service position and the motor unit is accessible;

the drive unit comprises a fixed portion;

the movable portion is hinged, to turn from the operative position to the service position, by a concealed hinge mechanism comprising an intermediate member connected to pivot relative to the each of the fixed portion and the movable portion about respective mutually parallel pivot axes.

The drive unit preferably comprises a lighting arrangement, of optical diffusing portions outboard of light sources, running about at least most of a periphery of the drive unit.

Another aspect of the invention provides a drive unit for driving a panel-lift door;

wherein the drive unit is mountable above an eyeline of an operator;

the drive unit comprises
a motor unit that lifts the door;
a housing; and
a lighting arrangement, of optical diffusing portions outboard of light sources, running about at least most of a periphery of the drive unit.

Preferably the housing comprises a movable portion that moves from an operative position to a service position. Most preferably the movable portion carries the lighting arrangement.

The lighting arrangement preferably encircles the periphery. Optionally an LED strip defines the light sources. The drive unit may comprise an integrally formed ring defining the optical diffusing portions.

Another aspect of the invention provides a panel-lift door installation comprising the drive unit.

Another aspect of the invention provides a motor unit for driving a panel-lift door;

a motor;

a gear box having a gear box housing;

an upwardly projecting output shaft;

a bracket comprising openings through which fasteners are upwardly drive-able to mount the motor unit; and

threaded fasteners passing downwardly through the bracket and engaging bores to fasten the gear box housing to the bracket.

### BRIEF DESCRIPTION OF DRAWINGS

FIG. 1 is a rear perspective view from below of a drive unit when closed;

FIG. 2 is a front perspective view from below of the drive unit when closed;

FIG. 3 is a front perspective view from below of the drive unit when open;

FIG. 4 corresponds to FIG. 3 with a housing wall unit hidden for clarity;

FIG. 5 corresponds to FIG. 4 with a housing hidden for clarity;

FIG. 6 is a front perspective view from below of the housing wall unit;

FIG. 7 is a rear perspective view from above of the housing wall unit;

FIG. 8 is a rear perspective view from below of a motor unit;

FIG. 9 is a front perspective view from above of the motor unit;

FIG. 10 is a front perspective view from above of a motor-gearbox combination;

FIG. 11 is a rear perspective view from above of an open drive unit;

FIG. 12 is a rear perspective view from above of an intermediate member;

FIG. 13 is a vertical cross-section view of a drive unit when open;

FIG. 14 is a front perspective cut-away view from above of the drive unit when open;

FIG. 15 is an enlargement of detail XV in FIG. 14;

FIG. 16 is a view corresponding to FIG. 15 and showing the drive unit when closed;

FIG. 17 is a front perspective cut-away view from below of the drive unit when closed; and

FIG. 18 is a front perspective cut-away view from below of an optical diffusing ring.

### DESCRIPTION OF EMBODIMENTS

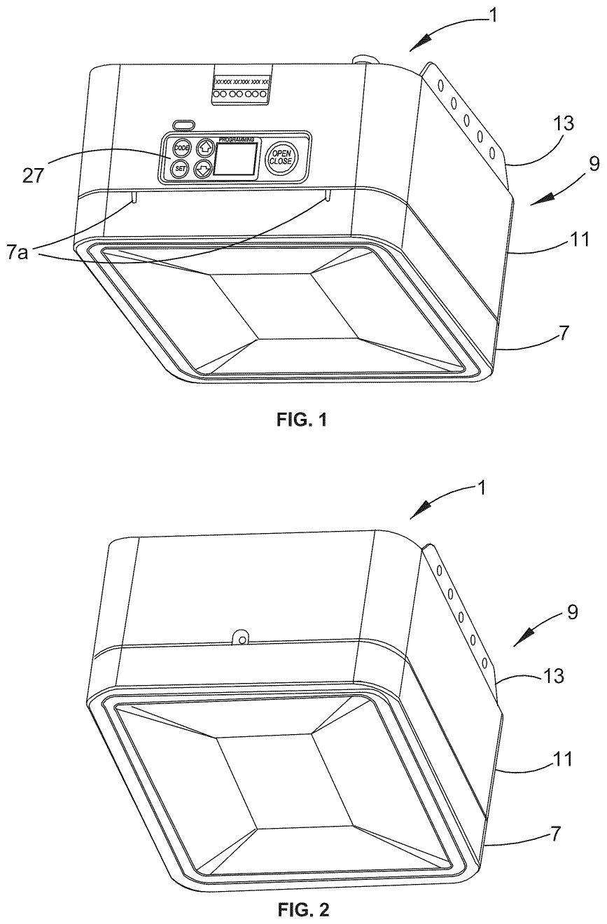

FIGS. 1 and 2 illustrate a drive unit 1 from below in its operative configuration as the unit would typically be viewed by an operator. The drive unit 1 comprises a motor unit 3 and further includes a movable portion 7 mounted to move with respect to a fixed portion 9. The fixed portion 9 comprises a housing body 11 and a chassis 13. The chassis 13 is a rectangular mounting plate. The housing body 11 defines upright walls that run about and project downwardly from the periphery of the chassis 13.

The movable portion 7, housing body 11 and chassis 13 together constitute a housing. The movable portion 7 defines a floor closing the bottom of the housing body 11 when the drive unit 1 is in its operative configuration. For service, the movable portion 7 drops away from the fixed portion 9 to present key components for service. In this example, the key components comprise the motor unit 3, a battery 15, a motor controller 17, an electronic user interface 21 and lighting unit 23.

The battery 15 is a back-up battery that stores energy sufficient to open the door if the main supply fails. The transformer 19 receives mains power and transforms the power to a lower voltage for driving the motor unit 3. The motor controller 17 takes the form of a printed circuit board (a PCB) and sits electrically between the transformer 19 and the motor unit 3. The motor controller 17 rectifies the alternated current received from the transformer 19 to provide direct current to the motor 3. The electronic user interface 21 is another PCB and comprises board-mounted buttons. The electronic user interface sits behind a user-contactable portion 27 mounted within a wall of the housing body 11 and comprising pliable portions by which the buttons are actuatable. The user-contactable portion 27 also includes a transparent portion that sits in register with a board mounted display (e.g. LCD display) of the electronic user interface 21.

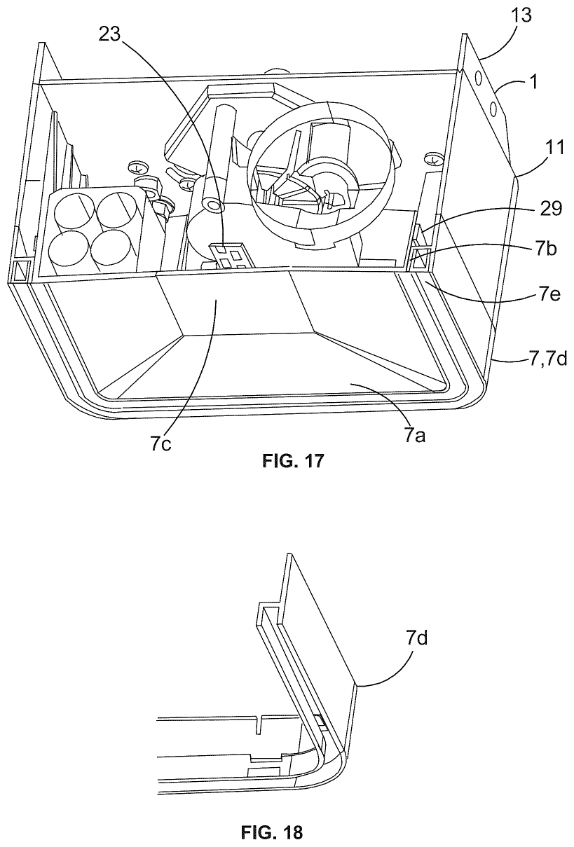

The lighting controller 23 is another PCB and conveys DC power from the motor controller 17 to the LED strip 29 (FIG. 17).

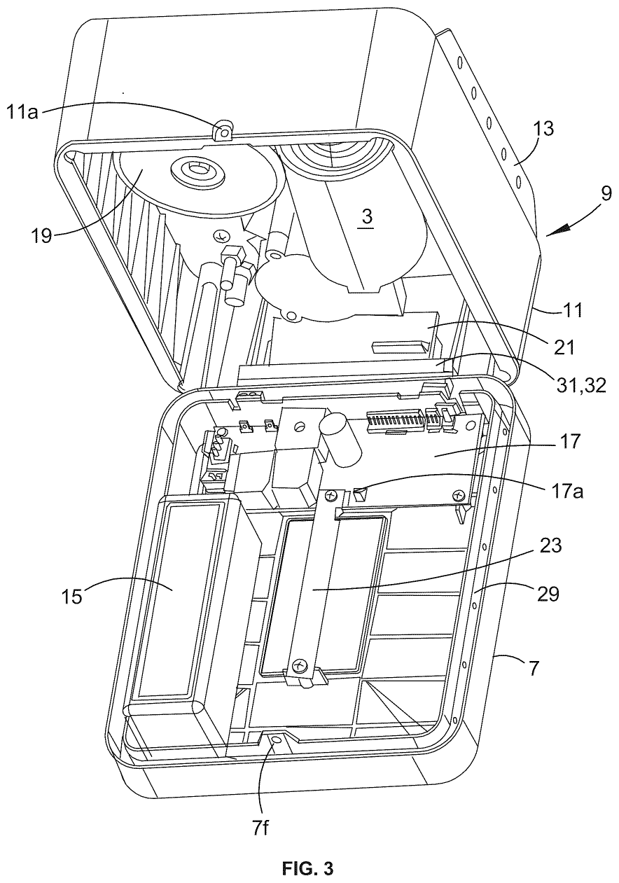

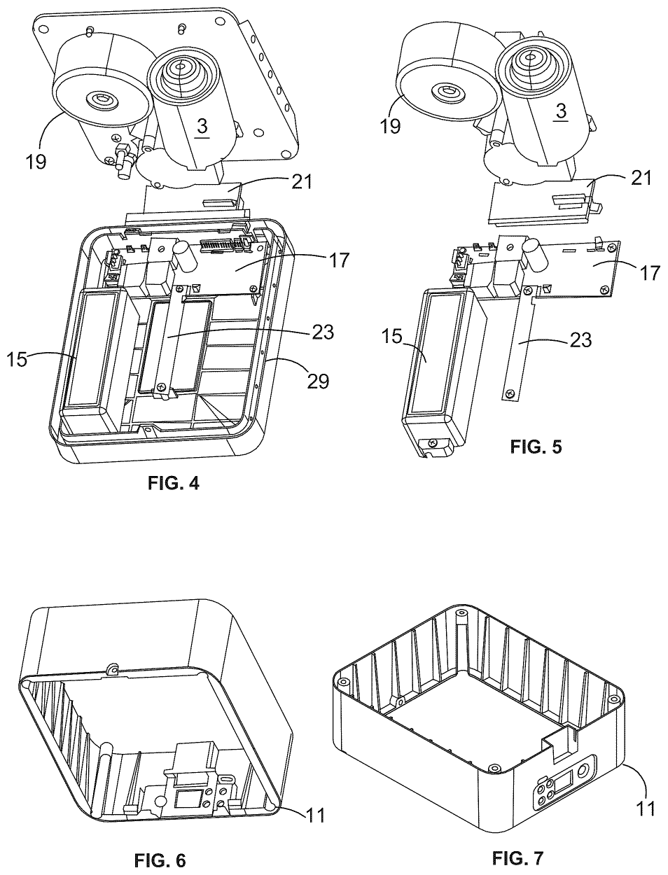

In this example of the drive unit, the key components are spread between the fixed portion 9 and the movable portion 7. This enables the key components to be closely packed when the drive unit is in its operative configuration. This close packing makes for a smaller drive unit that is aesthetically pleasing in use and less costly to ship and store. On the other hand, when the movable portion 7 moves away to its serviced position (FIG. 3) the key components are accessible for efficient servicing. In particular, in this example, the key components are not stacked atop one another so that each of the components 3, 15, 19, 21, 23 is removable, without removing any other one of those components, whilst the drive unit remains in situ in its elevated position. As illustrated in FIG. 3 the motor controller 17 sits behind the lighting unit 23 and comprises a hole 17a in register with a boss on which the lighting controller is mounted. The lighting controller 23 is mounted on two screws readily removable to leave the lighting controller hanging by its wiring to enable the motor controller 17 to be moved without fully removing the lighting controller.

Whilst in this example, there are six key components 3, 15, 17, 19, 21, 23 other drive units might have more or less key components. Various of the components might be integrated. Other variants may do without lighting and/or a battery backup. The motor controller 17 might be integrated with the motor unit 3. In other variations of the concept, the controllers might take the form of non-PCB control units.

In a simple implementation, the movable portion 7 might be entirely removable. Its service position could simply be any convenient location away from the fixed portion such as on a work bench, but preferably the movable portion 7 is retained, relative to the fixed portion, in its serviced position. In this example, the retention system takes the form of a concealed hinge 31. Other hinges, and mounting arrangements more generally, are possible.

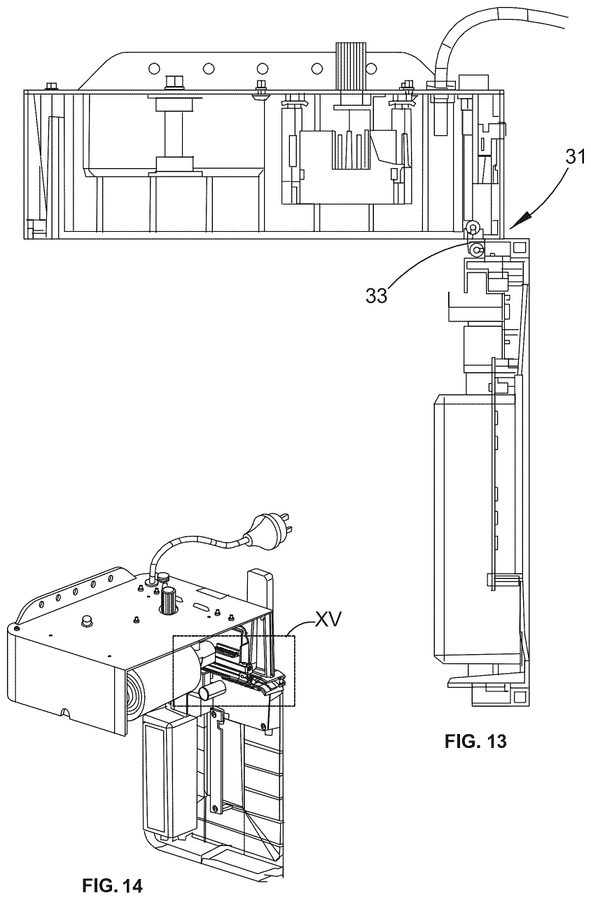

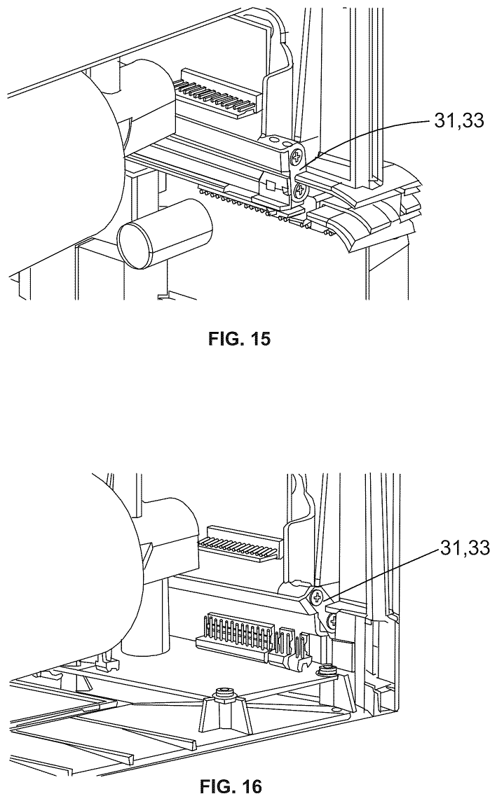

The hinge comprises a dual axis intermediate element 33 (FIGS. 12 to 16) mounted to pivot with respect to each of the portions 7, 9 about a respective pivot axis each corresponding to respective one of screws 35a and screws 35b. The screws 35a, 35b define pintles co-operable with hinge knuckles moulded into the components 7, 9. Other pintles are possible. The intermediate element 33 comprises a spacing portion 33a which runs parallel to the pivot axes and mutually connects a pair of vertical flanges 33b through which the screws 35a, 35b pass. A pair of slots 7a (FIG. 1) open through a top edge of the movable portion 7 to accommodate corresponding portions (flanges 33b in this case) of the intermediate element 33. Other portion-accommodating openings are possible.

This dual axis hinge advantageously enables the movable portion 7 to open wide for easy access to the key components whilst leaving the slots 7a as the only hint of the hinge when the drive unit 1 is in its operative configuration. As such the hinge 31 is an example of a concealed hinge. Whilst a preferred construction has been described, other concealed hinges might be adopted.

In this example, the movable portion 7 is rectangular. Whilst rectangular (e.g. square) is preferred other shapes are possible. In this particular orientation the hinge is mounted along one of the shorter edges of the rectangular movable portion 7. At the other end of the drive unit, holes 7f, 11a sit in register when the drive unit is closed and are skewered by a screw to restrain the movable portion 7 in the closed position. Other restraints are possible. By way of example, registered holes 7f, 11a might be replaced by a detent or latch arrangement. Alternatively the hinge might be an indexing hinge that causes the movable portion 7 to click into place, and restrains the movable portion 7, in its closed position.

The movable portion 7 comprises an opaque member 7a defining a floor and an upwardly projecting wall portion 7b running about the perimeter of that floor. A window opens centrally from the member 7a and is fitted with translucent optical diffuser 7c that sits in register with the lighting unit 23. This example of the lighting unit 23 takes the form of a PCB carrying LEDs. Lighting arrangement 7c, 23 spreads diffused light downwards from the unit 1.

The LED strip 29 runs about the outside of the wall 7b. In this example, the LED strip is adhered to the wall 7b. The LED strip defines point light sources around the periphery of the unit 1 and is surrounded by diffuser ring 7d. Components 29, 7d together constitute a lighting arrangement for laterally illuminating in all directions. This avoids the gloom that would arise if for example the lighting arrangement 7c, 23 was the only lighting arrangement whilst maintaining a compact construction, and improved aesthetic, relative to, say, adding a light bulb projecting downwardly below the vertical portion 7.

In this example, the diffuser 7d is an integrally formed body of polycarbonate and defines a pair of bottom edges separated by a downwardly open channel. Other materials and modes of construction are possible. The downwardly open channel carries an insert. In this example the insert is an opaque insert. A translucent insert is another option. The diffuser 7d serves as a light guide whereby from below a concentric pair of rectangular illuminated rings are visible.

The diffuser 7d is preferably formed by injection moulding. Advantageously to suit contexts in which the lateral illumination is not called for, the LED strip 29 may be omitted. Optionally the diffuser 7d may be replaced by an opaque component. The opaque component may be formed from the same injection moulding tool as the diffuser 7d thereby minimising tooling costs.

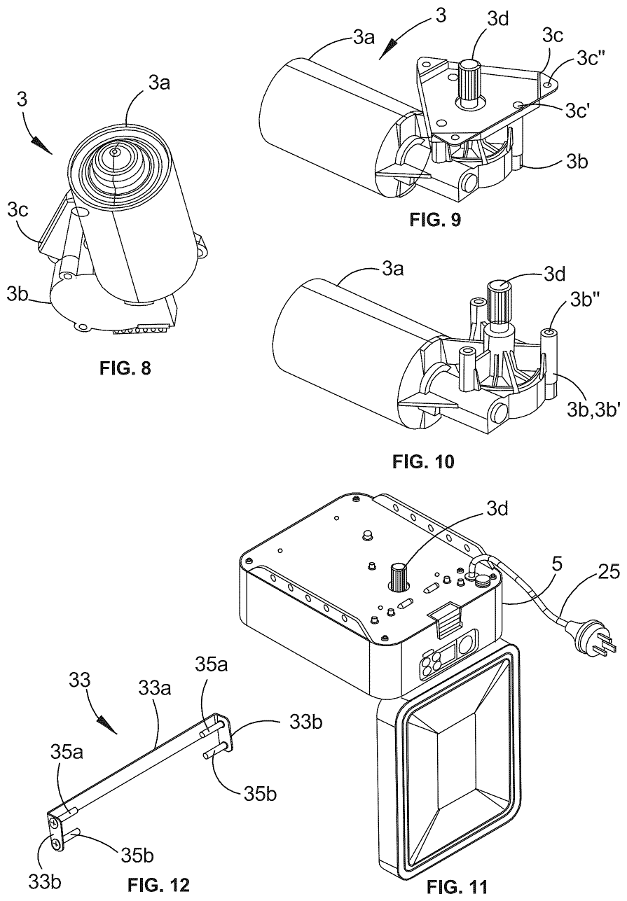

The top of the housing is closed by the chassis 13 (FIG. 11). This shields key components 3, 15, 17, 19, 21 and 23 from dust. A power cord 25 emerges from a top of the housing 5 to receive power from a main supply. Preferably the cord has a plug co-operable with a general power outlet (GPO). Turning to FIGS. 8 to 10, the motor unit 3 comprises an electric motor 3a, a gearbox 3b, a bracket 3c and an output shaft 3d that projects vertically out of the housing 5.

The gearbox 3b comprises a cast aluminium gearbox housing 3b′ that defines a trio of mounting legs each terminating in a respective mounting bore 3b″. Motor-gearbox combinations similar to the motor-gearbox combination 3a, 3b are economically available from a variety of a manufacturers. In preferred forms of the drive unit, adding the bracket 3c reduces servicing cost and leads to other advantages.

The bracket 3c comprises a trio of through holes 3c′ through which threaded fasteners are passed to engage the mounting bores 3b″ to fix the bracket 3c to the gearbox 3b and thus complete the motor unit 3.

The bracket 3c defines a further trio of through holes 3c″ through which motor-unit-mounting fasteners are passable to engage with the fixed portion 9 (or more specifically with the chassis 13 in this case) to mount the motor unit 3.

In this way the motor unit can be swapped out from below whilst the drive unit remains in situ. A service technician need only open the movable portion 7, undo the motor unit mounting fasteners (associated with through holes 3c″-FIG. 9) and disconnect the wiring to the motor unit. In contrast, prior art devices typically required the entire drive unit to be taken down to access fasteners associated with bores 3b″ from above the drive unit.

The bracket 3c also leads to efficiencies in manufacturing in that a variety of different brackets 3c can be used to mount a variety of different motor-gearbox combinations 3a, 3b having different mounting bore arrangements. This gives designers freedom to easily swap in and out different motors be it a stronger motor to suit a heavier door or to simply swap to an alternative motor from an alternative supplier.

The invention is not limited to the examples described herein. Rather, the invention is defined by the claims.

The term ‘comprises’ and its grammatical variants has a meaning that is determined by the context in which it appears. Accordingly, the term should not be interpreted exhaustively unless the context dictates so. Likewise, the article “a” or “an” preceding an element does not exclude the presence of a plurality of such elements unless the context dictates so.

1. A drive unit for driving a panel-lift door;
wherein the drive unit is mountable above an eyeline of an operator having a view;
the drive unit comprises:
a motor unit that lifts the door;
a housing comprising a movable portion that moves from an operative position to a service position; and
one or more key components carried by the movable portion;
each of the one or more key components carried by the movable portion is one of:
a battery;
a motor controller that controls the motor unit;
a transformer that transforms mains supply to power the motor unit;
an electronic user-interface that defines, or sits behind, a user contactable portion to
interface with a user;
a lighting unit; or
an arrangement of light sources;
the housing is reconfigurable in situ from:
an operative configuration in which the movable portion is in the operative position and the housing shields, the motor unit and the one or more key components carried by the movable portion, from the view of the operator; and
a service configuration in which the movable portion is in the service position and at least one of:
a) the motor unit or
b) at least one of the one or more key components carried by the movable portion is removable.

2. The drive unit of claim 1 wherein the movable portion defines a floor of the housing.

3. The drive unit of claim 1 wherein the movable portion carries the battery.

4. The drive unit of claim 1 wherein the movable portion carries the motor controller.

5. The drive unit of claim 1 wherein the service configuration is a configuration in which the motor unit is removable.

6. The drive unit of claim 1 comprising one or more threaded fasteners by which the motor unit is mounted;
wherein the one or more threaded fasteners each has a head accessible from below by which the fastener is removable to remove the motor unit from the drive unit in situ.

7. A drive unit for driving a panel-lift door;
wherein the drive unit is mountable above an eyeline of an operator;
the drive unit comprises:
a motor unit that lifts the door; and
a housing;
the housing comprises a movable portion that moves from an operative position to a service position;
the housing is reconfigurable in situ from:
an operative configuration in which the movable portion is in the operative position and the housing shields the motor unit from the view of the operator; and
a service configuration in which the movable portion is in the service position and the motor unit is removable;
the drive unit comprises one or more threaded fasteners by which the motor unit is mounted;
wherein the one or more threaded fasteners each has a head accessible from below by which the fastener is removable to remove the motor unit from the drive unit in situ.

8. The drive unit of claim 6 wherein the motor unit comprises:
a bracket through which the one or more threaded fasteners upwardly pass;
a gear box housing comprising bores; and
further threaded fasteners passing downwardly through the bracket and engaging the bores to fasten the gear box housing to the bracket.

9. The drive unit of claim 1 wherein the movable portion turns from transverse-to-upright in the operative position to upright in the service position.

10. The drive unit of claim 1 wherein the movable portion is hinged to turn from the operative position to the service position.

11. The drive unit of claim 1 comprising a fixed portion;
wherein the movable portion is hinged, to turn from the operative position to the service position, by a concealed hinge mechanism comprising an intermediate member connected to pivot relative to the each of the fixed portion and the movable portion about respective mutually parallel pivot axes.

12. A drive unit for driving a panel-lift door;
wherein the drive unit is mountable above an eyeline of an operator;
the drive unit comprises:
a motor unit that lifts the door; and
a housing;
the housing comprises a movable portion that moves from an operative position to a service position;
the housing is reconfigurable from:
an operative configuration in which the movable portion is in the operative position and the housing shields the motor unit from the view of the operator; and
a service configuration in which the movable portion is in the service position and the motor unit is accessible;
the drive unit comprises a fixed portion;
the movable portion is hinged, to turn from the operative position to the service position, by a concealed hinge mechanism comprising an intermediate member connected to pivot relative to the each of the fixed portion and the movable portion about respective mutually parallel pivot axes.

13. The drive unit of claim 1 comprising a lighting arrangement, of optical diffusing portions outboard of light sources, running about at least most of a periphery of the drive unit.

14. The drive unit of claim 13 wherein the movable portion carries the lighting arrangement.

15. The drive unit of claim 13 wherein the lighting arrangement encircles the periphery.

16. The drive unit of claim 13 comprising an LED strip defining the light sources.

17. The drive unit of claim 13 comprising an integrally formed ring defining the optical diffusing portions.
